(19) United States
(12) Patent Application Publication
(10) Pub. No.: US 2019/0210584 A1
(43) Pub. Date: Jul. 11, 2019

(54) Systems and Methods For Communication Via Hydraulic Fluid

(71) Applicant: Uber Technologies, Inc., San Francisco, CA (US)

(72) Inventor: Matthew Shaw Wood, Pittsburgh, PA (US)

(21) Appl. No.: 15/882,325

(22) Filed: Jan. 29, 2018

Related U.S. Application Data
(60) Provisional application No. 62/615,740, filed on Jan. 10, 2018.

(51) Int. Cl. B60T 17/22; B60T 13/66; B60T 8/172; B60T 7/12

(52) U.S. Cl. CPC B60T 17/22; B60T 7/12; B60T 8/172; B60T 13/662

(57) ABSTRACT

The present disclosure provides systems and methods for communicating between control systems via hydraulic fluid. In one example embodiment, a computer-implemented method includes operating a first pressure regulating device associated with a first control system to regulate a fluid pressure of hydraulic fluid being supplied through a hydraulic line, the first pressure regulating device being in fluid communication with a hydraulically actuated component via the hydraulic line. The method includes controlling the operation of the first pressure regulating device to generate a fluid-pressure based signal within the hydraulic line, the signal providing an indication of an operational status of at least one of the first control system or the hydraulically actuated component. The method includes detecting pressure changes within the hydraulic line associated with the signal to allow a second control system to monitor the operational status of the first control system and/or the hydraulically actuated component.

### PRIORITY CLAIM

The present application claims the benefit of priority of U.S. Provisional Patent Application No. 62/615,740 filed Jan. 10, 2018, entitled “Systems and Methods For Communication Via Hydraulic Fluid.” The above-referenced patent application is incorporated herein by reference.

### FIELD

The present application relates generally to autonomous vehicles and, more particularly, the systems and methods for communicating via hydraulic fluid to control an autonomous vehicle.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion plan through such surrounding environment.

### SUMMARY

Aspects and advantages of the present disclosure will be set forth in part in the following description, or may be learned from the description, or may be learned through practice of the embodiments.

One example aspect of the present disclosure is directed to a computer-implemented method for communicating between control systems via hydraulic fluid. The method includes operating, by one or more computing devices, a first pressure regulating device associated with a first control system to regulate a fluid pressure of hydraulic fluid being supplied through a hydraulic line, the first pressure regulating device being in fluid communication with a hydraulically actuated component via the hydraulic line. The method includes controlling, by the one or more computing devices, the operation of the first pressure regulating device to generate a fluid-pressure based signal within the hydraulic line, the fluid-pressure based signal providing an indication of an operational status of at least one of the first control system or the hydraulically actuated component. The method includes detecting, by the one or more computing devices, pressure changes within the hydraulic line associated with the fluid-pressure based signal to allow a second control system to monitor the operational status of at least one of the first control system or the hydraulically actuated component.

Another example aspect of the present disclosure is directed to a system for communicating between control systems via hydraulic fluid. The computing system includes a hydraulically actuated component, a first control system, and a second control system. The first control system includes a first pressure regulating device in fluid communication with the hydraulically actuated component via a hydraulic line, the first control system configured to control an operation of the first pressure regulating device to regulate a fluid pressure of hydraulic fluid supplied through the hydraulic line so as to generate a fluid-pressure based signal within the hydraulic line, the fluid-pressure based signal providing an indication of an operational status of at least one of the first control system or the hydraulically actuated component. The second control system includes a second pressure regulating device in fluid communication with the hydraulically actuated component via the hydraulic line, the second control system being configured to monitor the operational status of at least one of the first control system or the hydraulically actuated component by detecting pressure changes within the hydraulic line associated with the fluid-pressure based signal.

Yet another example aspect of the present disclosure is directed to non-transitory computer-readable medium storing instructions that, when executed by one or more computing devices, cause the one or more computing devices to perform operations. The operations include operating a first pressure regulating device associated with a first control system to regulate a fluid pressure of hydraulic fluid being supplied through a hydraulic line, the first pressure regulating device being in fluid communication with a hydraulically actuated component via the hydraulic line. The operations include controlling the operation of the first pressure regulating device to generate a fluid-pressure based signal within the hydraulic line, the fluid-pressure based signal providing an indication of an operational status of at least one of the first control system or the hydraulically actuated component. The operations include detecting pressure changes within the hydraulic line associated with the fluid-pressure based signal to allow a second control system to monitor the operational status of at least one of the first control system or the hydraulically actuated component.

Other example aspects of the present disclosure are directed to systems, methods, vehicles, apparatuses, tangible, non-transitory computer-readable media, and memory devices for controlling an autonomous vehicle.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth below, which make reference to the appended figures, in which:

FIG. 1 depicts an example system overview according to example embodiments of the present disclosure;

FIG. 2 depicts an example vehicle computing system for controlling an autonomous vehicle according to example embodiments of the present disclosure;

FIG. 3 depicts an example vehicle control system according to example embodiments of the present disclosure;

FIGS. 4A-4D depict example fluid-pressure based signals according to example embodiments of the present disclosure;

FIG. 5 depicts a flow diagram of controlling an autonomous vehicle according to example embodiments of the present disclosure; and

FIG. 6 depicts example system components according to example embodiments of the present disclosure.

Reference numerals that are repeated across plural figures are intended to identify the same components or features in various implementations.

### DETAILED DESCRIPTION

Example aspects of the present disclosure are directed to systems and methods for communicating between two or more systems via hydraulic fluid. As an example, an autonomous vehicle can include a first braking control system and a second braking control system in case of a component failure in the first or second braking control system. The autonomous vehicle can provide one or more commands to the first and/or second braking control system to implement a stopping action. In response to the one or more commands, the first and second braking control systems can control one or more hydraulically actuated brake components to implement the stopping action. In particular, the first and second braking control systems can be in fluid communication with the one or more brake components via one or more brake fluid hydraulic lines. The first and second brake control systems can measure and regulate a fluid pressure of hydraulic fluid (e.g., brake fluid) being supplied through the brake lines. In case of a component failure in the autonomous vehicle that causes the autonomous vehicle to be unable to provide commands to the first and second braking control systems, the first and second braking control systems can control the one or more brake components to bring the autonomous vehicle to a safe stop. In this case, the first braking control system can be unaware of an operational status of the second braking control system, and vice versa. Aspects of the present disclosure can enable the first braking control system and second braking control system to communicate via a fluid pressure of brake fluid being supplied through the one or more brake fluid hydraulic lines (e.g., brake lines). In particular, the first braking control system can regulate a brake fluid pressure in one or more brake lines to transmit one or more fluid-pressure based signals. The second braking control system can monitor a brake fluid pressure in the one or more brake lines to detect the one or more fluid-pressure based signals. In this way, the first and second braking control systems can communicate and coordinate control of the one or more brake components to bring the autonomous vehicle to a safe stop.

More particularly, an autonomous vehicle can include a vehicle computing system that implements a variety of systems on-board the autonomous vehicle (e.g., located on or within the autonomous vehicle) for autonomous navigation. For instance, the vehicle computing system can include an autonomy computing system (e.g., for planning and executing autonomous navigation), and a vehicle control system (e.g., for controlling one or more systems responsible for powertrain, steering, braking, etc.).

An autonomy computing system of the autonomous vehicle can include one or more autonomy system(s) for planning and executing autonomous navigation. For instance, an autonomy computing system can include, among other systems, a perception system, a prediction system, and a motion planning system that cooperate to perceive a surrounding environment of an autonomous vehicle and determine a motion plan for controlling a motion of the autonomous vehicle. The motion plan can include one or more trajectories (e.g., trajectory information) that cause the autonomous vehicle to travel from a starting location to an ending location when executed. The autonomy computing system can provide the motion plan to a vehicle control system to implement the motion plan.

A vehicle control system of the autonomous vehicle can include one or more system(s) for controlling the autonomous vehicle. The vehicle control system can receive a motion plan from the autonomy computing system, and generate one or more vehicle commands to control the one or more system(s) in accordance with the motion plan. The vehicle control system can include, for example, a powertrain control system, steering control system, braking control system, etc. The one or more vehicle commands can, for example, instruct the powertrain control system to control one or more hydraulically actuated propulsion components to accelerate the autonomous vehicle, instruct the steering control system to control one or more hydraulically actuated steering components to steer the autonomous vehicle, instruct the braking control system to control one or more hydraulically actuated braking components to slow and/or stop the autonomous vehicle, etc.

In some implementations, the one or more system(s) included in the vehicle control system can include further low-level control logic to control the autonomous vehicle in case of a component failure in the autonomous vehicle. As an example, the steering control system can include low-level control logic to keep the steering rack at a desired position by controlling one or more hydraulically actuated steering components. As an another example, the braking control system can include low-level control logic to slow and stop the autonomous vehicle by controlling one or more hydraulically actuated braking components.

In some implementations, the braking control system can include one or more braking actuators in fluid communication with one or more hydraulically actuated brake components via one or more brake lines. The one or more braking actuators can include, for example, one or more valve assemblies or other pressure regulating devices that can monitor and regulate a fluid pressure of brake fluid being supplied through the brake lines. The vehicle control system can generate a vehicle command to, for example, instruct the braking control system to implement a stopping action. In response to the vehicle command, the braking control system can increase a fluid pressure within one or more brake lines via one or more braking actuators. When the fluid pressure within a brake line reaches an actuating pressure, the corresponding hydraulically actuated brake component is engaged.

As an example, the braking control system can include first, second, third, and fourth braking actuators in fluid communication with first, second, third, and fourth brake components via first, second, third, and fourth brake lines, respectively. In response to a vehicle command, the braking control system can control the first, second, third, and fourth braking actuators to increase a fluid pressure within the first, second, third, and fourth brake lines to an actuating pressure causing the first, second, third, and fourth brake components to engage. Additionally and/or alternatively, in response to a vehicle command, the braking control system can control the first, second, third, and fourth braking actuators to regulate a fluid pressure within the first, second, third, and fourth brake lines according to an actuation delivery control strategy.

In some implementations, the braking control system can include a first braking control system and a second braking control system that can provide system-level redundancy in case of a component failure. The first braking control system can include a first set of braking actuators in fluid communication with one or more brake components of the autonomous vehicle. The second braking control system can include a second set of braking actuators in fluid communication with the one or more brake components. For example, each of the first and second braking control systems can be in fluid communication with each brake component of the autonomous vehicle, via the first and second set of braking actuators, respectively. The vehicle control system can generate one or more vehicle commands to, for example, instruct the first braking control system to implement a stopping action via one or more braking actuators in the first set, and/or instruct the second braking control system to implement the stopping action via one or more braking actuators in the second set.

As an example, the first braking control system can include first, second, third, and fourth braking actuators (e.g., a first set of braking actuators) and the second braking control system can include fifth, sixth, seventh, and eighth braking actuators (e.g., a second set of braking actuators). The first and fifth braking actuators can be in fluid communication with a first brake component via a first brake line; the second and sixth braking actuators can be in fluid communication with a second brake component via a second brake line; the third and seventh braking actuators can be in fluid communication with a third brake component via a third brake line; and the fourth and eighth braking actuators can be in fluid communication with a fourth brake component via a fourth brake line. The vehicle control system can instruct the first braking control system to control the first, second, third, and fourth brake components via the first, second, third, and fourth braking actuators. If the vehicle control system detects a component failure in the first braking actuator, then the vehicle control system can instruct the second braking control system to control the first, second, third, and fourth brake components via the fifth, sixth, seventh, and eighth braking actuators. Alternatively, if the vehicle control system detects a component failure in the first braking actuator, then the vehicle control system can instruct the first braking control system to control the second, third, and fourth brake components via the second, third, and fourth braking actuators; and instruct the second braking control system to control the first brake component via the fifth braking actuator.

In some implementations, the first and second braking control systems can include further low-level control logic in case of a component failure in the autonomous vehicle. As an example, the first braking control system can include low-level control logic to control one or more brake components of the autonomous vehicle via a first set of braking actuators to implement a stopping action in case of a component failure in the autonomous vehicle that causes the vehicle control system to be unable to control the autonomous vehicle in accordance with a motion plan. In addition, the second braking control system can include low-level control logic to control the one or more brake components of the autonomous vehicle via a second set of braking actuators to implement the stopping action in case of the component failure.

In some implementations, the first and second braking control systems can regulate a fluid pressure in one or more brake lines to generate one or more fluid-pressure based signals within the one or more brake lines. As an example, the first braking control system can include a first braking actuator in fluid communication with a first brake component via a first brake line. The first braking control system can control the first braking actuator to generate pressure changes within the first brake line. The first braking control system can generate the pressure changes based on a fluid pressure amplitude and frequency associated with, for example, a modulated pressure signal. The second braking control system can include a second braking actuator in fluid communication with the first brake component via the first brake line. The second braking control system can control the second braking actuator to measure the pressure changes within the first brake line. The second braking control system can detect the modulated pressure signal based on the measured pressure changes. In addition, the second braking control system can control the second braking actuator to generate pressure changes within the first brake line, and the first braking control system can control the first braking actuator to measure the pressure changes within the first brake line. In this way, the first and second braking control systems can communicate via the hydraulic fluid being supplied in the first brake line. The first and second braking control systems can communicate to, for example, determine an operational status associated with each other and/or one or more hydraulically activated brake components in fluid communication with one or the other braking control system.

The fluid pressure amplitude associated with a modulated pressure signal transmitted within the first brake line can be greater than a nominal fluid pressure within the first brake line and less than an actuating fluid pressure within the first brake line. The nominal fluid pressure can correspond to a fluid pressure within the first brake line when the first brake component is disengaged, and when there are no fluid-pressure based signals being transmitted within the first brake line. By setting the fluid pressure amplitude associated with the modulated pressure signal greater than the nominal fluid pressure, the modulated pressure signal can be detected more easily. The actuating fluid pressure can correspond to a fluid pressure within the first brake line that causes the first brake component to engage. By setting the fluid pressure amplitude associated with the modulated pressure signal less than the actuating pressure signal, the modulated pressure signal can be transmitted without engaging the first brake component.

In some implementations, a fluid-pressure based signal can provide an indication of an operational status of the first braking control system and/or one or more hydraulically activated brake components in fluid communication with the first braking control system. The first braking control system can access a lookup table that includes a predetermined set of operational states in association with one or more fluid-pressure based signals (e.g., modulated pressure signals). The lookup table can further include, for example, a predetermined pressure amplitude, pressure frequency, and pressure rise time associated with each modulated pressure signal, a hydraulic line associated with each modulated pressure signal, vehicle instructions associated with each modulated pressure signal, etc.

As an example, the lookup table can include a modulated pressure signal associated with a component failure in the first braking control system. In response to detecting the component failure, the first braking control system can transmit the modulated pressure signal associated with the component failure. When the second braking control system detects the modulated pressure signal, the second braking control system can determine that an operational status of the first braking control system includes the component failure.

As another example, the lookup table can include a modulated pressure signal associated with a healthy operation state of the first braking control system. The first braking control system can transmit the modulated pressure signal so long as the first braking control system does not detect a component failure in the first braking control system. In this case, the second braking control system can determine an operational status of the first braking control system as not healthy (e.g., there is a component failure in the first braking control system) if the second braking control system fails to detect the modulated pressure signal.

As another example, the lookup table can include a modulated pressure signal associated with a pressure amplitude P₁ and frequency T₁. The first braking control system can access the lookup table to determine the amplitude P₁ and frequency T₁. The first braking control system can generate pressure changes in a hydraulic brake line according to the amplitude P₁ and frequency T₁ to transmit the modulated pressure signal. The second braking control system can measure a fluid pressure in the hydraulic brake line to detect the pressure changes and access the lookup table to determine the modulated pressure signal associated with the detected pressure changes.

As another example, the lookup table can include a modulated pressure signal associated with vehicle instructions in response to detecting the modulated pressure signal. The vehicle instructions can include, for example, instructions for the second braking control system to assume control of a first brake component if the modulated pressure signal is associated with a component failure in the first braking control system, instructions to implement a vehicle actuation control strategy that is indicated by the modulated pressure signal, etc. In response to detecting the modulated pressure signal, the second braking control system can access the lookup table to determine the vehicle instructions associated with the modulated pressure signal, and implement the associated vehicle instructions.

As another example, the lookup table can include a modulated pressure signal associated with a pressure amplitude P₁, frequency T₁, and rise time R₁. The second braking control system can measure a rise time of one or more detected pressure changes to determine a component failure in the first braking control system even if the first braking control system does not transmit a modulated pressure signal that indicates the component failure. The second braking control system can determine a component failure in the first braking control system based on a deviation of a measured rise time for a detected modulated pressure signal from the rise time R₁ associated with the detected modulated pressure signal.

As another example, the lookup table can include a first modulated pressure signal associated with a fluid pressure amplitude P₁, frequency T₁, and hydraulic brake line B₁; and a second modulated pressure signal associated with a pressure amplitude P₁, frequency T₁, and hydraulic brake line B₂. If the second braking control system detects pressure changes corresponding to the amplitude P₁ and frequency T₁ within brake line B₁, then the second braking control system can determine that the first modulated pressure signal is detected. If the second braking control system detects pressure changes corresponding to the amplitude P₁ and frequency T₁ within brake line B₂, then the second braking control system can determine that the second modulated pressure signal is detected.

As another example, the lookup table can include a first modulated pressure signal associated with a pressure amplitude P₁, frequency T₁, and hydraulic brake line B₁; and a second modulated pressure signal associated with a pressure amplitude P₂, frequency T₂, and hydraulic brake line B₁. The first braking control system can transmit the first and second modulated pressure signals within the brake line B₁, and the second braking control system can detect the first and second modulated pressure signals within the brake line B₁.

The systems and methods described herein provide a number of technical effects and benefits. Systems and methods for controlling an autonomous vehicle by regulating a hydraulic fluid pressure in a hydraulic line to communicate between two or more control systems onboard the autonomous vehicle can enable the control systems to communicate in the case of a component failure causing the autonomous vehicle to be unable to provide instructions to the control systems. In this way, the control systems can communicate and coordinate and control one or more hydraulically actuated vehicle components to maintain control of the autonomous vehicle in case of one or more such component failures.

The systems and methods of the present disclosure also provide an improvement to vehicle computing technology, such as autonomous vehicle computing technology. For instance, the systems and methods herein enable the vehicle technology to provide a second/backup communication channel between two or more redundant control systems without requiring additional hardware. For example, the systems and methods can allow the two or more systems on-board an autonomous vehicle to effectively coordinate and control one or more hydraulically actuated components of the autonomous vehicle in response to a component failure in the autonomous vehicle. In this way, the autonomous vehicle can operate to more safely, reliably, and efficiently perform autonomous navigation.

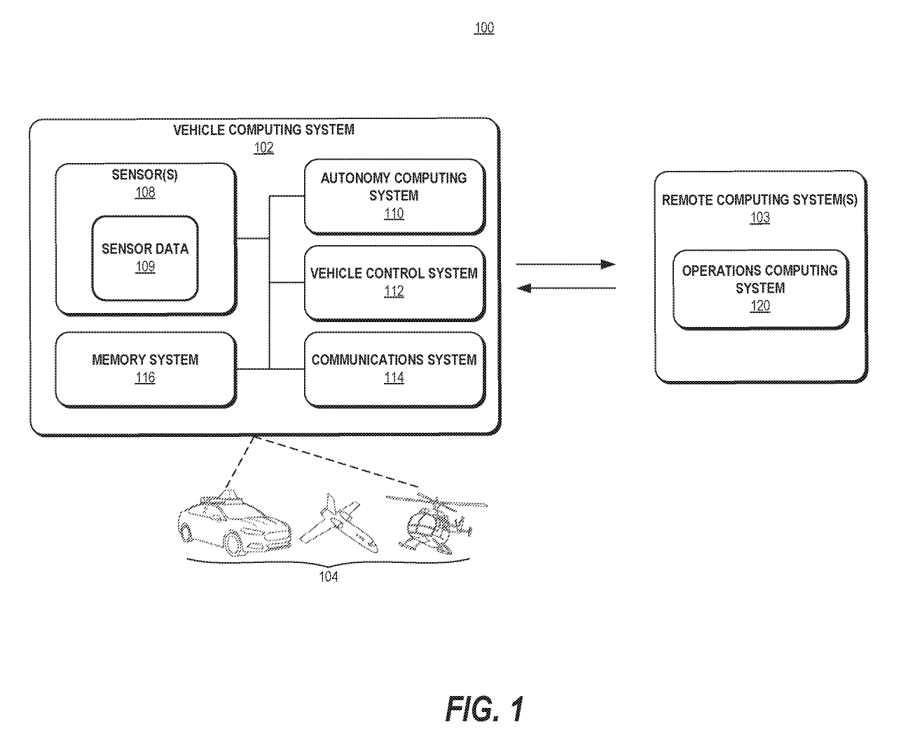

With reference now to the FIGS., example embodiments of the present disclosure will be discussed in further detail. FIG. 1 depicts an example system 100 according to example embodiments of the present disclosure. The system 100 can include a vehicle computing system 102 associated with a vehicle 104.

In some implementations, the system 100 can include one or more remote computing system(s) 103 that are remote from the vehicle 104. The remote computing system(s) 103 can include an operations computing system 120. The remote computing system(s) 103 can be separate from one another or share computing device(s). The operations computing system 120 can remotely manage the vehicle 104.

The vehicle computing system 102 can include one or more computing device(s) located on-board the vehicle 104 (e.g., located on and/or within the vehicle 104). The computing device(s) can include various components for performing various operations and functions. For instance, the computing device(s) can include one or more processor(s) and one or more tangible, non-transitory, computer readable media. The one or more tangible, non-transitory, computer readable media can store instructions that when executed by the one or more processor(s) cause the vehicle 104 (e.g., its computing system, one or more processors, etc.) to perform operations and functions, such as those described herein.

As shown in FIG. 1, the vehicle 104 can include one or more sensors 108, an autonomy computing system 110, a vehicle control system 112, a communications system 114, and a memory system 116. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The on-board systems can send and/or receive data, messages, signals, etc. amongst one another via the communication channel.

The sensor(s) 108 can be configured to acquire sensor data 109 associated with one or more objects that are proximate to the vehicle 104 (e.g., within a field of view of one or more of the sensor(s) 108). The sensor(s) 108 can include a Light Detection and Ranging (LIDAR) system, a Radio Detection and Ranging (RADAR) system, one or more cameras (e.g., visible spectrum cameras, infrared cameras, etc.), motion sensors, and/or other types of imaging capture devices and/or sensors. The sensor data 109 can include image data, radar data, LIDAR data, and/or other data acquired by the sensor(s) 108. The object(s) can include, for example, pedestrians, vehicles, bicycles, and/or other objects. The object(s) can be located in front of, to the rear of, and/or to the side of the vehicle 104. The sensor data 109 can be indicative of locations associated with the object(s) within the surrounding environment of the vehicle 104 at one or more times. The sensor(s) 108 can provide the sensor data 109 to the autonomy computing system 110.

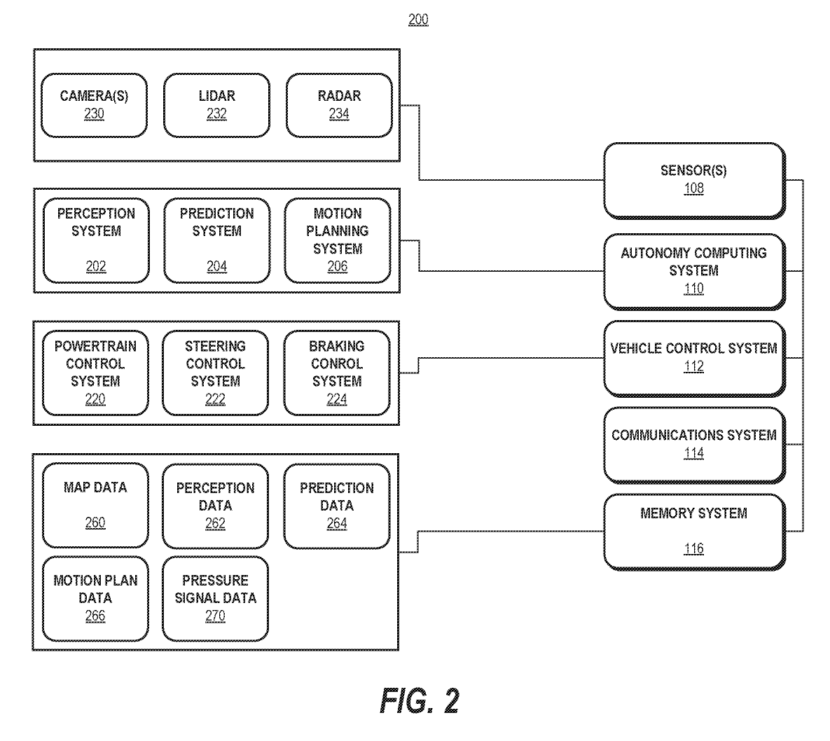

As shown in FIG. 2, the autonomy computing system 110 can include a perception system 202, a prediction system 204, a motion planning system 206, and/or other systems that cooperate to perceive the surrounding environment of the vehicle 104 and determine a motion plan for controlling the motion of the vehicle 104 accordingly. For example, the autonomy computing system 110 can receive the sensor data 109 from the sensor(s) 108, attempt to comprehend the surrounding environment by performing various processing techniques on the sensor data 109 (and/or other data), and generate an appropriate motion plan through such surrounding environment. The autonomy computing system 110 can control the one or more vehicle control systems 112 to operate the vehicle 104 according to the motion plan.

The autonomy computing system 110 can identify one or more objects that are proximate to the vehicle 104 based at least in part on the sensor data 109. For instance, the perception system 202 can perform various processing techniques on the sensor data 109 to determine perception data 262 that is descriptive of a current state of one or more object(s) that are proximate to the vehicle 104. The prediction system 204 can create prediction data 264 associated with each of the respective one or more object(s) proximate to the vehicle 104. The prediction data 264 can be indicative of one or more predicted future locations of each respective object. The motion planning system 206 can determine a motion plan for the vehicle 104 based at least in part on the prediction data 264 (and/or other data), and save the motion plan as motion plan data 266. The motion plan data 266 can include vehicle actions with respect to the object(s) proximate to the vehicle 104 as well as the predicted movements. The motion plan data 266 can include a planned trajectory, speed, acceleration, etc. of the vehicle 104.

The motion planning system 206 can provide at least a portion of the motion plan data 266 that indicates one or more vehicle actions, a planned trajectory, and/or other operating parameters to the vehicle control system 112 to implement the motion plan for the vehicle 104. For instance, the vehicle 104 can include a mobility controller configured to translate the motion plan data 266 into instructions. By way of example, the mobility controller can translate the motion plan data 266 into instructions to adjust the steering of the vehicle 104 “X” degrees, apply a certain magnitude of braking force, etc. The mobility controller can send one or more control signals to one or more responsible system(s) included in the vehicle control system (e.g., powertrain control system 220, steering control system 222, braking control system 224) to execute the instructions and implement the motion plan.

The communications system 114 can allow the vehicle computing system 102 (and its computing system(s)) to communicate with other computing systems (e.g., remote computing system(s) 103). For example, the vehicle computing system 102 can use the communications system 114 to communicate with the operations computing system 120 over one or more networks (e.g., via one or more wireless signal connections). In some implementations, the communications system 114 can allow communication among one or more of the system(s) on-board the vehicle 104. The communications system 114 can include any suitable sub-systems for interfacing with one or more network(s), including, for example, transmitters, receivers, ports, controllers, antennas, and/or other suitable sub-systems that can help facilitate communication.

The memory system 116 of the vehicle 104 can include one or more memory devices located at the same or different locations (e.g., on-board the vehicle 104, distributed throughout the vehicle 104, off-board the vehicle 104, etc.). The vehicle computing system 102 can use the memory system 116 to store and retrieve data/information. For instance, the memory system 116 can store map data 260, perception data 262, prediction data 264, motion plan data 266, detected fault data 270, and fault response data 272.

The map data 260 can include information regarding: an identity and location of different roadways, road segments, buildings, or other items or objects (e.g., lampposts, crosswalks, curbing, etc.); a location and direction of traffic lanes (e.g., the location and direction of a parking lane, a turning lane, a bicycle lane, or other lanes within a particular roadway or other travel way and/or one or more boundary markings associated therewith); and/or any other data that assists the vehicle computing system 102 in comprehending and perceiving its surrounding environment and its relationship thereto.

The pressure signal data 270 can include, for example, a lookup table. In particular, the pressure signal data 270 can include information regarding a predetermined set of operational states, and one or more modulated pressure signals associated with each of the operational states. The pressure signal data 270 can further include a predetermined fluid pressure amplitude, frequency, and/or rise time associated with each of the one or more modulated pressure signals. The predetermined fluid pressure amplitude can be below a threshold fluid pressure that is less than an actuating fluid pressure. The threshold fluid pressure can be set so that transmitting one or more modulated pressure signals in a hydraulic line does not accidentally actuate a vehicle component in fluid communication with the hydraulic line. The pressure signal data 270 can further include one or more hydraulic lines and/or vehicle instructions associated with each of the one or more modulated pressure signals.

In some implementations, the pressure signal data 270 can include information regarding one or more constant pressure signals associated with each of the operational states. The pressure signal data 270 can further include a predetermined fluid pressure associated with each of the one or more constant pressure signals. The predetermined fluid pressure can be below a threshold fluid pressure that is less than an actuating fluid pressure. The predetermined fluid pressure can be associated with a confidence threshold indicating a pressure range that includes the predetermined fluid pressure. The pressure signal data 270 can further include one or more hydraulic lines and/or vehicle instructions associated with each of the one or more constant pressure signals.

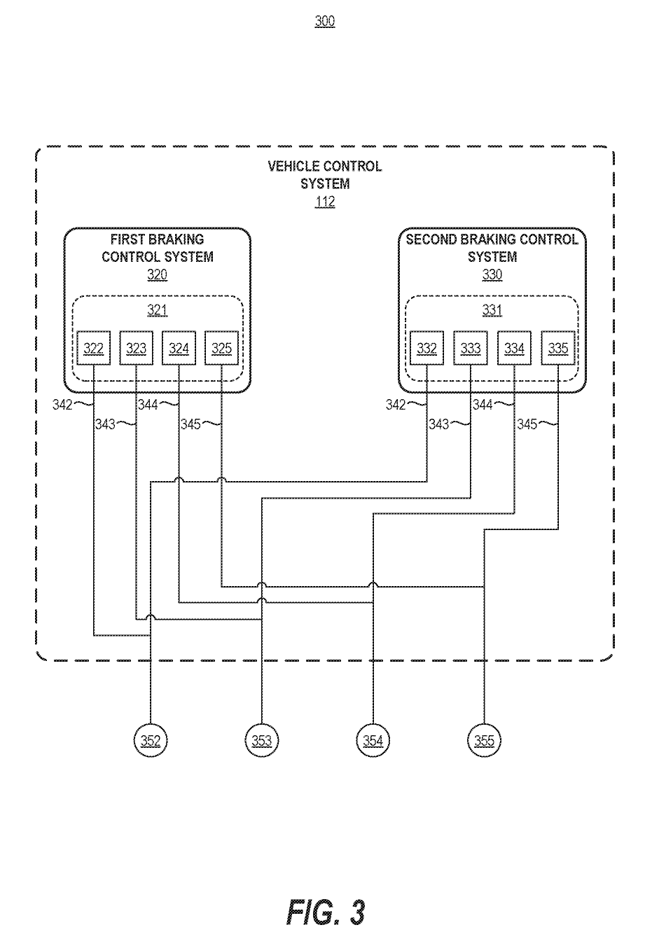

FIG. 3 depicts a diagram 300 of the vehicle control system 112 with a redundant braking architecture. The redundant braking architecture can include a first braking control system 320 and a second braking control system 330. The hydraulically actuated brake components 352, 353, 354, and 355 can be controlled via the first braking control system 320 and the second braking control system 330. The vehicle control system 112 can use the first braking control system 320 or the second braking control system 330 to control any one of the brake components 352, 353, 354, and 355, so that both the first braking control system 320 and the second braking control system 330 are not used simultaneously to control the same brake component of the vehicle 104. If a component failure occurs, for example, in the first braking control system 320 with respect to the first brake component 352, then the vehicle computing system 102 can maintain control of the first brake component 352 via the second braking control system 330. In this way, the redundant braking architecture can provide redundancy in case of a component failure in the vehicle 104.

The first braking control system 320 can include a first set of braking actuators 321 in fluid communication with the brake components 352, 353, 354, and 355. The first set of braking actuators 321 can include braking actuators 322, 323, 324, and 325. The braking actuators 322, 323, 324, and 325 can be in fluid communication with the brake components 352. 353, 354, and 355, via brake lines 342, 343, 344, and 345, respectively.

The first braking control system 321 can regulate and monitor a fluid pressure of brake fluid supplied through the brake lines 342, 343, 344, and 345, via the braking actuators 322, 323, 324, and 325, respectively. As an example, the first braking control system 321 can increase a fluid pressure of the brake fluid within one or more of the brake lines 342, 343, 344, and 345 to an actuating pressure to engage one or more of the brake components 352, 353, 354, and 355, respectively. As another example, the first braking control system 321 can decrease a fluid pressure of the brake fluid within one or more of the brake lines 342, 343, 344, and 345 to below an actuating pressure to disengage one or more of the brake components 352, 353, 354, and 355, respectively. As yet another example, the first braking control system 321 can regulate a fluid pressure within one or more of the brake lines 342, 343, 344, and 345 to generate one or more modulated pressure signals.

The second braking control system 330 can include a second set of braking actuators 331 in fluid communication with the brake components 352, 353, 354, and 355. The second set of braking actuators 331 can include braking actuators 332, 333, 334, and 335. The braking actuators 332, 333, 334, and 335 can be in fluid communication with the brake components 352. 353, 354, and 355, via brake lines 342, 343, 344, and 345, respectively.

The second braking control system 331 can regulate and monitor a fluid pressure of brake fluid supplied through the brake lines 342, 343, 344, and 345, via the braking actuators 332, 333, 334, and 335, respectively. As an example, the second braking control system 331 can increase a fluid pressure of the brake fluid within one or more of the brake lines 342, 343, 344, and 345 to an actuating pressure to engage one or more of the brake components 352, 353, 354, and 355, respectively. As another example, the second braking control system 331 can decrease a fluid pressure of the brake fluid within one or more of the brake lines 342, 343, 344, and 345 to below an actuating pressure to disengage one or more of the brake components 352, 353, 354, and 355, respectively. As yet another example, the second braking control system 331 can regulate a fluid pressure within one or more of the brake lines 342, 343, 344, and 345 to generate one or more modulated pressure signals.

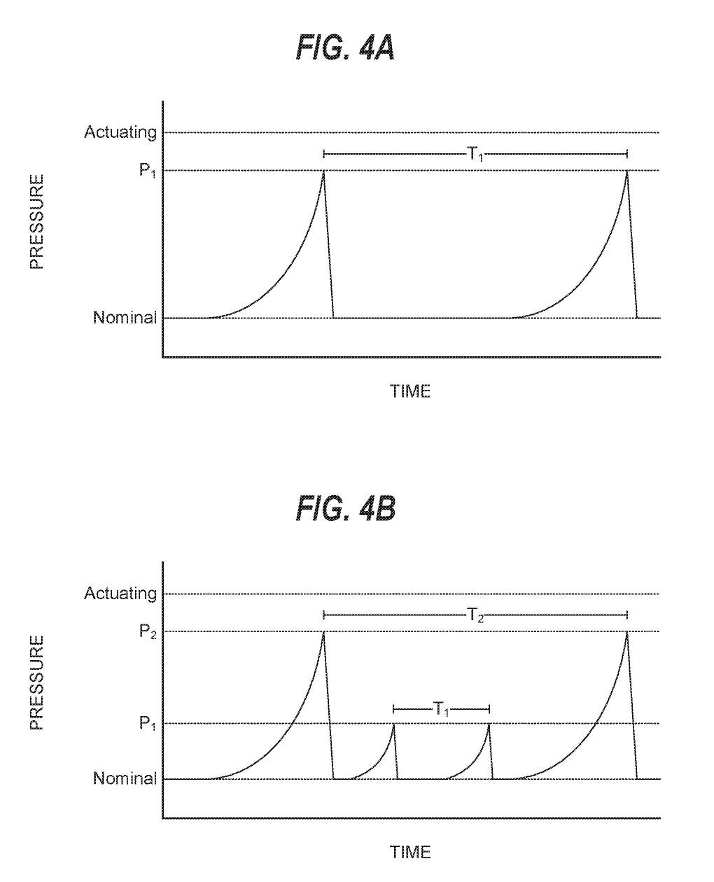

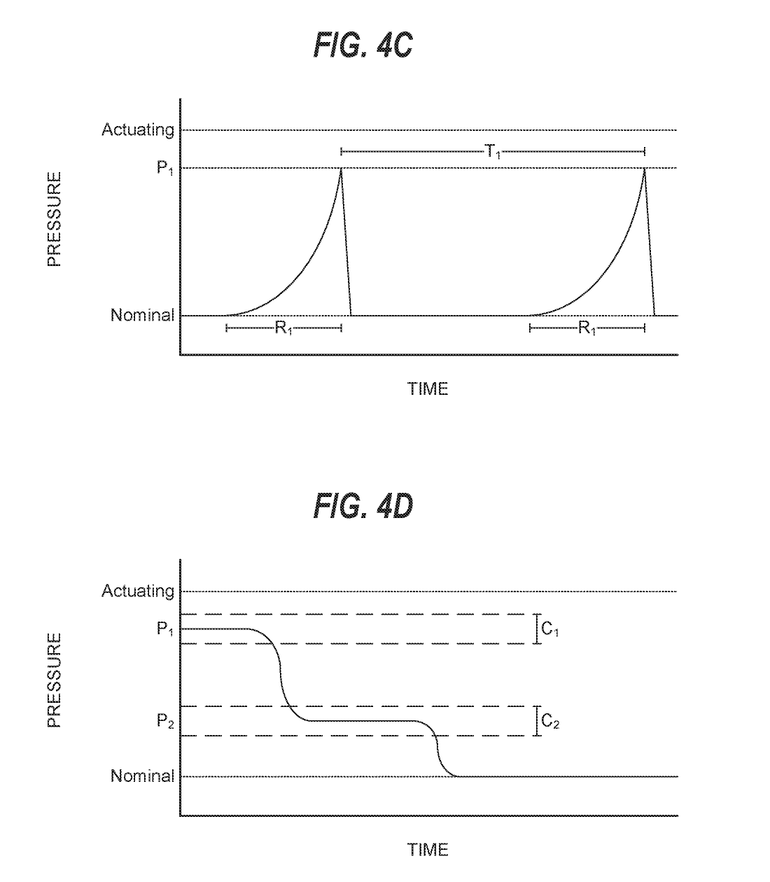

FIGS. 4A-4D depict example pressure signals that a braking control system (e.g., the first braking control system 321 and/or the second braking control system 330) can generate within a brake line (e.g., one or more of the brake lines 342, 343, 344, and 345). In particular, FIGS. 4A-4C depict example modulated pressure signals, and FIG. 4D depicts example constant pressure signals.

As shown in FIG. 4A, a modulated pressure signal can be associated with a pressure amplitude P₁ and frequency T₁. The braking control system can generate the modulated pressure signal by increasing a fluid pressure in the brake line from a nominal pressure to the pressure P₁ at a frequency of T₁.

As shown in FIG. 4B, a first modulated pressure signal can be associated with a pressure amplitude P₁ and frequency T₁, and a second modulated pressure signal can be associated with a pressure amplitude P₂ and frequency T₂. The braking control system can generate both the first and second modulated pressure signals in the brake line by increasing a fluid pressure in the brake line to the pressure P₁ at a frequency of T₁, and increasing a fluid pressure in the brake line to the pressure P₂ at a frequency of T₂.

As shown in FIG. 4C, a modulated pressure signal can be associated with a pressure amplitude P₁ and frequency T₁, and rise time R₁. The braking control system can generate the modulated pressure signal by increasing a fluid pressure in the brake line from a nominal pressure to the pressure P₁ at a frequency of T₁. The braking control system can generate the modulated pressure signal by increasing the fluid pressure from the nominal pressure to the pressure P₁ according to the rise time R₁.

As shown in FIG. 4D, the braking control system can generate a constant pressure signal instead of a modulated pressure signal. A first constant pressure signal can be associated with a pressure P₁, confidence threshold C₁, and a healthy operation state. A second constant pressure signal can be associated with a pressure of P₂, and a degraded operation state. The first braking control system 320 can generate the first constant pressure signal within the brake line if the first braking control system 320 is associated with the healthy operation state, and generate the second constant pressure signal within the brake line if the first braking control system 320 is associated with the degraded operation state. The second braking control system 330 can monitor a fluid pressure in the brake line and determine that the first braking control system 320 is associated with the healthy operation state so long as the fluid pressure in the brake line is within the confidence threshold C₁. If the fluid pressure in the brake line falls to within the confidence threshold C₂ associated with the second constant pressure signal, then the second braking control system 330 can determine that the first braking control system 320 is associated with the degraded operation state. If the fluid pressure in the brake line falls below the confidence threshold C₂, then the second braking control system 330 can determine that the first braking control system 320 is not operational.

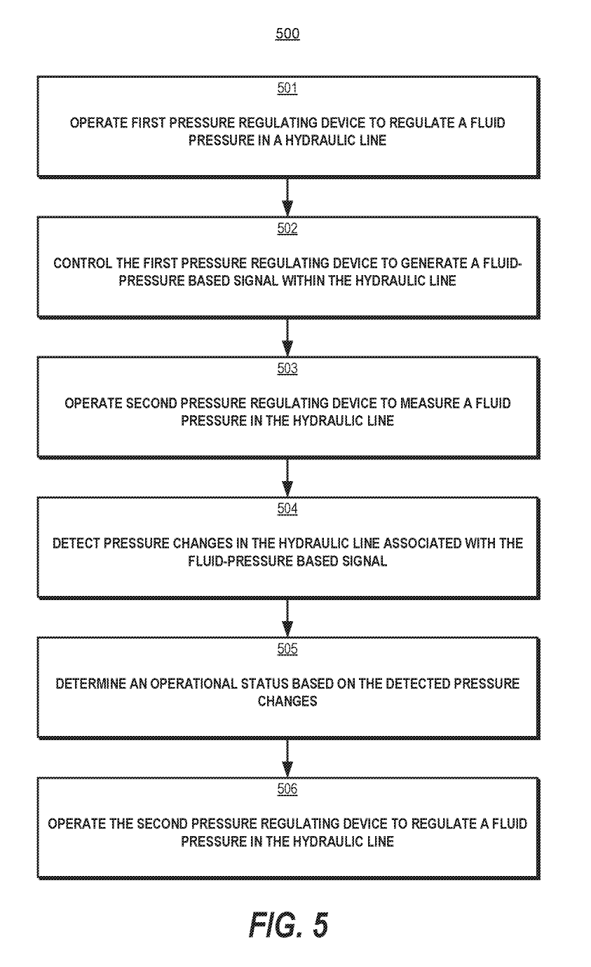

FIG. 5 depicts a flow diagram of an example method 500 for controlling an autonomous vehicle according to example embodiments of the present disclosure. One or more portion(s) of the method 500 can be implemented as operations by one or more computing system(s) such as, for example, the computing system(s) 102, 120, 601, and 610 shown in FIGS. 1, 2, and 6. Moreover, one or more portion(s) of the method 500 can be implemented as an algorithm on the hardware components of the system(s) described herein (e.g., as in FIGS. 1, 2, and 6) to, for example, control an autonomous vehicle.

FIG. 5 depicts elements performed in a particular order for purposes of illustration and discussion. Those of ordinary skill in the art, using the disclosures provided herein, will understand that the elements FIG. 5 discussed herein can be adapted, rearranged, expanded, omitted, combined, and/or modified in various ways without deviating from the scope of the present disclosure.

At (501), the method 500 can include operating a first pressure regulating device to regulate a fluid pressure in a hydraulic line. For example, the vehicle computing system 102 can operate one or more of the braking actuators 322, 323, 324, and 325 associated with the first braking control system 320 to regulate a fluid pressure of hydraulic fluid being supplied through one or more of the brake lines 342, 343, 344, and 345. The braking actuators 322, 323, 324, and 325 can be in fluid communication with the brake components 352, 353, 354, and 355, via the brake lines 342, 343, 344, and 345, respectively.

At (502), the method 500 can include controlling the first pressure regulating device to generate a fluid-pressure based signal within the hydraulic line. For example, the vehicle computing system 102 can control one or more of the braking actuators 322, 323, 324, and 325 to generate a fluid-pressure based signal within one or more of the brake lines 342, 343, 344, and 345. The fluid-pressure based signal can provide an indication of an operational status of at least one of the first braking control system 320, brake component 352, brake component 353, brake component 354, or brake component 355. In particular, the vehicle computing system 102 can determine a pressure amplitude and a pressure frequency associated with the fluid-pressure based signal, and control the operation of one or more of the braking actuators 322, 323, 324, and 325 to generate the fluid-pressure based signal based at least in part on the pressure amplitude and the pressure frequency. The pressure amplitude can correspond to a fluid pressure of the hydraulic fluid that is greater than a nominal fluid pressure within one or more of the brake lines 342, 343, 344, and 345; and less than an actuating fluid pressure within one or more of the brake lines 342, 343, 344, and 345.

At (503), the method 500 can include operating a second pressure regulating device to measure a fluid pressure in the hydraulic line. For example, the vehicle computing system 102 can operate one or more of the braking actuators 332, 333, 334, and 335 associated with the second braking control system 330 to measure a fluid pressure of hydraulic fluid being supplied through one or more of the brake lines 342, 343, 344, and 345.

At (504), the method 500 can include detecting pressure changes in the hydraulic line associated with the fluid-pressure based signal. For example, the vehicle computing system 102 can detect pressure changes within one or more of the brake lines 342, 343, 344, and 345 associated with the fluid-pressure based signal to allow the second braking control system 330 to monitor the operational status of at least one of the first braking control system 320, brake component 352, brake component 353, brake component 354, or brake component 355. In particular, the vehicle computing system 102 can control one or more of the braking actuators 332, 333, 334, and 335 to detect the pressure changes within one or more of the brake lines 342, 343, 344, and 345.

At (505), the method 500 can include determining an operational status based on the detected pressure changes. For example, the vehicle computing system 102 can determine the operational status of at least one of the first braking control system 320, brake component 352, brake component 353, brake component 354, or brake component 355, based at least in part on the detected pressure changes. In particular, the vehicle computing system 102 can determine the fluid-pressure based signal associated with the detected pressure changes based at least in part on a predetermined set of pressure changes associated with one or more fluid-pressure based signals. The vehicle computing system 102 can determine the operational status based at least in part on a predetermined set of operational states associated with the one or more fluid-pressure based signals.

At (506), the method 500 can include operating the second pressure regulating device to regulate a fluid pressure in the hydraulic line. For example, the vehicle computing system 102 can determine a component failure based at least in part on the operational status of at least one of the first braking control system 320, brake component 352, brake component 353, brake component 354, or brake component 355. In response to determining the component failure, the vehicle computing system 102 can operate one or more of the braking actuators 332, 333, 334, and 335 of the second braking control system 330 to regulate a fluid pressure of hydraulic fluid being supplied through one or more of the brake lines 342, 343, 344, and 345.

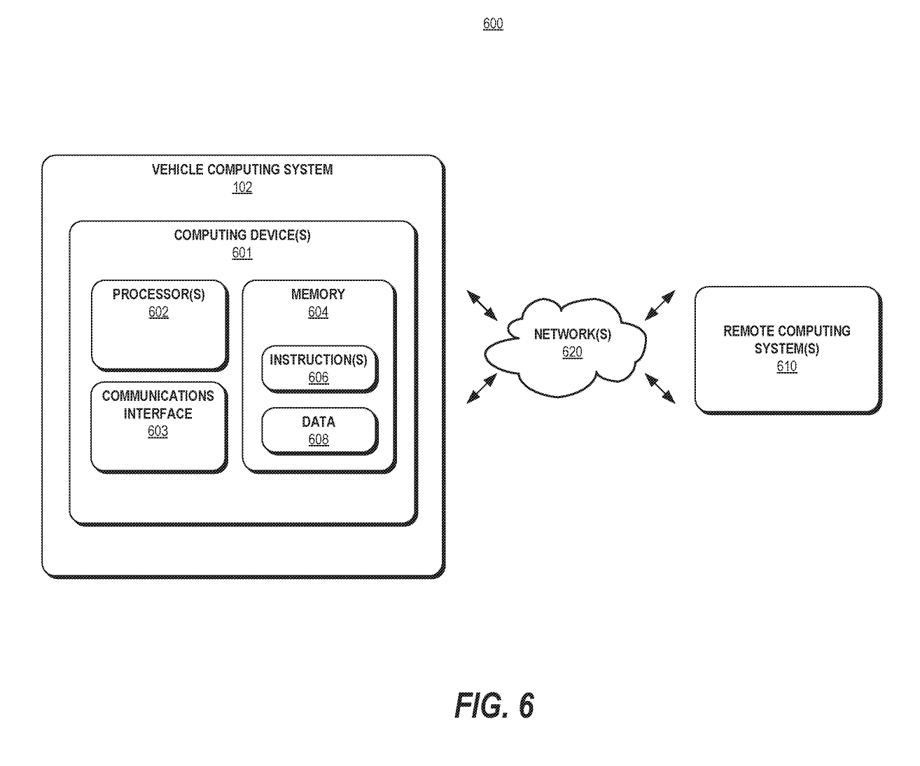

FIG. 6 depicts an example computing system 600 according to example embodiments of the present disclosure. The example system 600 illustrated in FIG. 6 is provided as an example only. The components, systems, connections, and/or other aspects illustrated in FIG. 6 are optional and are provided as examples of what is possible, but not required, to implement the present disclosure. The example system 600 can include the vehicle computing system 102 of the vehicle 104 and, in some implementations, remote computing system(s) 610 including one or more remote computing system(s) that are remote from the vehicle 104 (e.g., the operations computing system 120) that can be communicatively coupled to one another over one or more networks 620. The remote computing system(s) 610 can be associated with a central operations system and/or an entity associated with the vehicle 104 such as, for example, a vehicle owner, vehicle manager, fleet operator, service provider, etc.

The computing device(s) 601 of the vehicle computing system 102 can include processor(s) 602 and a memory 604. The one or more processors 602 can be any suitable processing device (e.g., a processor core, a microprocessor, an ASIC, a FPGA, a controller, a microcontroller, etc.) and can be one processor or a plurality of processors that are operatively connected. The memory 604 can include one or more non-transitory computer-readable storage media, such as RAM, ROM, EEPROM, EPROM, one or more memory devices, flash memory devices, etc., and combinations thereof.

The memory 604 can store information that can be accessed by the one or more processors 602. For instance, the memory 604 (e.g., one or more non-transitory computer-readable storage mediums, memory devices) on-board the vehicle 104 can include computer-readable instructions 606 that can be executed by the one or more processors 602. The instructions 606 can be software written in any suitable programming language or can be implemented in hardware. Additionally, or alternatively, the instructions 606 can be executed in logically and/or virtually separate threads on processor(s) 602.

For example, the memory 604 on-board the vehicle 104 can store instructions 606 that when executed by the one or more processors 602 on-board the vehicle 104 cause the one or more processors 602 (the vehicle computing system 102) to perform operations such one or more operations of method 500 and/or any of the operations and functions of the vehicle computing system 102, as described herein.

The memory 604 can store data 608 that can be obtained, received, accessed, written, manipulated, created, and/or stored. The data 608 can include, for instance, data associated with perception, prediction, motion plan, maps, hydraulic fluid pressure signal(s), and/or other data/information as described herein. In some implementations, the computing device(s) 601 can obtain data from one or more memory device(s) that are remote from the vehicle 104.

The computing device(s) 601 can also include a communication interface 603 used to communicate with one or more other system(s) on-board the vehicle 104 and/or a remote computing device that is remote from the vehicle 104 (e.g., of remote computing system(s) 610). The communication interface 603 can include any circuits, components, software, etc. for communicating via one or more networks (e.g., 620). In some implementations, the communication interface 603 can include, for example, one or more of a communications controller, receiver, transceiver, transmitter, port, conductors, software, and/or hardware for communicating data.

The network(s) 620 can be any type of network or combination of networks that allows for communication between devices. In some embodiments, the network(s) can include one or more of a local area network, wide area network, the Internet, secure network, cellular network, mesh network, peer-to-peer communication link, and/or some combination thereof, and can include any number of wired or wireless links. Communication over the network(s) 620 can be accomplished, for instance, via a communication interface using any type of protocol, protection scheme, encoding, format, packaging, etc.

The remote computing system 610 can include one or more remote computing devices that are remote from the vehicle computing system 102. The remote computing devices can include components (e.g., processor(s), memory, instructions, data) similar to that described herein for the computing device(s) 601. Moreover, the remote computing system(s) 610 can be configured to perform one or more operations of the operations computing system 120, as described herein. Moreover, the computing systems of other vehicles described herein can include components similar to that of vehicle computing system 102.

Computing tasks discussed herein as being performed at computing device(s) remote from the vehicle can instead be performed at the vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for communicating between control systems via hydraulic fluid, the method comprising:
operating, by one or more computing devices, a first pressure regulating device associated with a first control system to regulate a fluid pressure of hydraulic fluid being supplied through a hydraulic line, the first pressure regulating device being in fluid communication with a hydraulically actuated component via the hydraulic line;
controlling, by the one or more computing devices, the operation of the first pressure regulating device to generate a fluid-pressure based signal within the hydraulic line, the fluid-pressure based signal providing an indication of an operational status of at least one of the first control system or the hydraulically actuated component; and
detecting, by the one or more computing devices, pressure changes within the hydraulic line associated with the fluid-pressure based signal to allow a second control system to monitor the operational status of at least one of the first control system or the hydraulically actuated component.

2. The computer-implemented method of claim 1, wherein detecting, by the one or more computing devices, pressure changes within the hydraulic line associated with fluid-pressure based signal to allow a second control system to monitor the operational status of at least one of the first control system or the hydraulically actuated component comprises:
operating, by the one or more computing devices, a second pressure regulating device associated with the second control system to measure a fluid pressure of hydraulic fluid being supplied through the hydraulic line;
controlling, by the one or more computing devices, the operation of the second pressure regulating device to detect pressure changes within the hydraulic line; and
determining, by the one or more computing devices, the operational status of at least one of the first control system or the hydraulically actuated component based at least in part on the detected pressure changes.

3. The computer-implemented method of claim 2, further comprising:
determining, by the one or more computing devices, a component failure based at least in part on the operational status of at least one of the first control system or the hydraulically actuated component; and
operating, by the one or more computing devices, the second pressure regulating device of the second control system to regulate a fluid pressure of hydraulic fluid being supplied through the hydraulic line, in response to the component failure.

4. The computer-implemented method of claim 3, wherein determining, by the one or more computing devices, the operational status of at least one of the first control system or the hydraulically actuated component based at least in part on the detected pressure changes comprises:
determining, by the one or more computing devices, the fluid-pressure based signal associated with the detected pressure changes based at least in part on a predetermined set of pressure changes associated with one or more fluid-pressure based signals; and
determining, by the one or more computing devices, the operational status based at least in part on a predetermined set of operational states associated with the one or more fluid-pressure based signals.

5. The computer-implemented method of claim 1, wherein controlling, by the one or more computing devices, the operation of the first pressure regulating device to generate a fluid-pressure based signal within the hydraulic line, the fluid-pressure based signal providing an indication of an operational status of at least one of the first control system or the hydraulically actuated component comprises:
determining, by the one or more computing devices, a pressure amplitude and a pressure frequency associated with the fluid-pressure based signal; and
controlling, by the one or more computing devices, the operation of the first pressure regulating device to generate the fluid-pressure based signal based at least in part on the pressure amplitude and pressure frequency.

6. The computer-implemented method of claim 5, wherein the pressure amplitude corresponds to a fluid pressure of the hydraulic fluid that is greater than a nominal fluid pressure within the hydraulic line and that is less than an actuating fluid pressure within the hydraulic line.

7. The computer-implemented method of claim 5, further comprising:
determining, by the one or more computing devices, a fluid pressure rise time associated with the fluid-pressure based signal; and
controlling, by the one or more computing devices, the operation of the first pressure regulating device to generate the fluid-pressure based signal based at least in part on the fluid pressure rise time.

8. A system for communicating between control systems via hydraulic fluid, the system comprising:
a hydraulically actuated component;
a first control system including a first pressure regulating device in fluid communication with the hydraulically actuated component via a hydraulic line, the first control system configured to control an operation of the first pressure regulating device to regulate a fluid pressure of hydraulic fluid supplied through the hydraulic line so as to generate a fluid-pressure based signal within the hydraulic line, the fluid-pressure based signal providing an indication of an operational status of at least one of the first control system or the hydraulically actuated component; and
a second control system including a second pressure regulating device in fluid communication with the hydraulically actuated component via the hydraulic line, the second control system being configured to monitor the operational status of at least one of the first control system or the hydraulically actuated component by detecting pressure changes within the hydraulic line associated with the fluid-pressure based signal.

9. The system of claim 8, wherein the second control system is configured to determine a component failure in the first control system based at least in part on the operational status of at least one of the first control system or the hydraulically actuated component, and control an operation of the second pressure regulating device to regulate a fluid pressure of hydraulic fluid supplied through the hydraulic line.

10. The system of claim 8, wherein the second pressure regulating device is configured to measure a fluid pressure of hydraulic fluid supplied through the hydraulic line, and the second control system is configured to control an operation of the second pressure regulating device to detect pressure changes within the hydraulic line and determine the operational status of at least one of the first control system or the hydraulically actuated component based at least in part on the detected pressure changes.

11. The system of claim 10, wherein the second control system is configured to determine the fluid-pressure based signal associated with the detected pressure changes based at least in part on a predetermined set of pressure changes associated with one or more fluid-pressure based signals, and determine the operational status based at least in part on a predetermined set of operational states associated with the one or more fluid-pressure based signals.

12. The system of claim 8, wherein the first control system is configured to determine a pressure amplitude and a pressure frequency associated with the fluid-pressure based signal, and control the operation of the first pressure regulating device to generate the fluid-pressure based signal based at least in part on the pressure amplitude and pressure frequency.

13. The system of claim 12, wherein the pressure amplitude corresponds to a fluid pressure of the hydraulic fluid that is greater than a nominal fluid pressure within the hydraulic line and that is less than an actuating fluid pressure within the hydraulic line.

14. A non-transitory computer-readable medium storing instructions that, when executed by one or more computing devices, cause the one or more computing devices to perform operations, the operations comprising:
operating a first pressure regulating device associated with a first control system to regulate a fluid pressure of hydraulic fluid being supplied through a hydraulic line, the first pressure regulating device being in fluid communication with a hydraulically actuated component via the hydraulic line;
controlling the operation of the first pressure regulating device to generate a fluid-pressure based signal within the hydraulic line, the fluid-pressure based signal providing an indication of an operational status of at least one of the first control system or the hydraulically actuated component; and
detecting pressure changes within the hydraulic line associated with the fluid-pressure based signal to allow a second control system to monitor the operational status of at least one of the first control system or the hydraulically actuated component.

15. The non-transitory computer-readable medium of claim 14, wherein detecting pressure changes within the hydraulic line associated with fluid-pressure based signal to allow a second control system to monitor the operational status of at least one of the first control system or the hydraulically actuated component comprises:
operating a second pressure regulating device associated with the second control system to measure a fluid pressure of hydraulic fluid being supplied through the hydraulic line;
controlling the operation of the second pressure regulating device to detect pressure changes within the hydraulic line; and
determining the operational status of at least one of the first control system or the hydraulically actuated component based at least in part on the detected pressure changes.

16. The non-transitory computer-readable medium of claim 15, further comprising:
determining a component failure based at least in part on the operational status of at least one of the first control system or the hydraulically actuated component; and
operating the second pressure regulating device of the second control system to regulate a fluid pressure of hydraulic fluid being supplied through the hydraulic line, in response to the component failure.

17. The non-transitory computer-readable medium of claim 14, wherein determining the operational status of at least one of the first control system or the hydraulically actuated component based at least in part on the detected pressure changes comprises:
determining the fluid-pressure based signal associated with the detected pressure changes based at least in part on a predetermined set of pressure changes associated with one or more fluid-pressure based signals; and
determining the operational status based at least in part on a predetermined set of operational states associated with the one or more fluid-pressure based signals.

18. The non-transitory computer-readable medium of claim 14, wherein controlling the operation of the first pressure regulating device to generate a fluid-pressure based signal within the hydraulic line, the fluid-pressure based signal providing an indication of an operational status of at least one of the first control system or the hydraulically actuated component comprises:
determining a pressure amplitude and a pressure frequency associated with the fluid-pressure based signal; and
controlling the operation of the first pressure regulating device to generate the fluid-pressure based signal based at least in part on the pressure amplitude and pressure frequency.

19. The non-transitory computer-readable medium of claim 18, wherein the pressure amplitude corresponds to a fluid pressure of the hydraulic fluid that is greater than a nominal fluid pressure within the hydraulic line and that is less than an actuating fluid pressure within the hydraulic line.

20. The non-transitory computer-readable medium of claim 18, further comprising:
determining a fluid pressure rise time associated with the fluid-pressure based signal; and
controlling the operation of the first pressure regulating device to generate the fluid-pressure based signal based at least in part on the fluid pressure rise time.
